(19) United States
(12) Patent Application Publication
(10) Pub. No.: US 2004/0101453 A1
(43) Pub. Date: May 27, 2004

(54) Apparatus for purifying exhaust gases

(75) Inventor: Takahiko Fujiwara, Susono-shi (JP)

Correspondence Address: Finnegan, Henderson, Farabow,, Garrett & Dunner, L.L.P., 1300 I Street, N.W., Washington, DC, 20005-3315, US

(73) Assignee: Toyota Jidosha Kabushiki Kaisha

(21) Appl. No.: 10/713,255

(22) Filed: Nov. 17, 2003

(30) Foreign Application Priority Data
Nov. 26, 2002 (JP) 2002-342064

(51) Int. Cl. B01D 53/34

(52) U.S. Cl. 422/177; 422/171

(57) ABSTRACT

An apparatus is for purifying exhaust gases, and includes an HC adsorption-purifying catalyst and a three-way catalyst. The HC adsorption-purifying catalyst includes an HC adsorbent, and an oxidizing catalyst. The three-way catalyst is disposed on an upstream side of the flow of exhaust gases with respect to the HC adsorption-purifying catalyst, wherein a noble metal is loaded higher on a high loading portion disposed on an upstream part of the three-way catalyst than on an ordinary part of the three-way catalyst. The apparatus shows the actions of the three-way catalyst and the actions of the HC adsorption-purifying catalyst synergistically, and accordingly can remarkably inhibit the HC emission even in low-temperature regions such as when engines are started.

### BACKGROUND OF THE INVENTION

1. Field of the Invention

The present invention relates to an apparatus for purifying exhaust gases, apparatus which uses an adsorbent for hydrocarbons (HC). More particularly, it relates to an apparatus for purifying exhaust gases, apparatus which can control the emission of HC well in low temperature regions such as when engines are started.

2. Description of the Related Art

Zeolite is also known as a molecular sieve. Accordingly, zeolite has micro pores whose pore diameter is less than 2 nm and is equal to the sizes of molecules. Not only zeolite has been used as an adsorbent, but also has been used as a catalyst in a variety of reactions. Moreover, zeolite has many acidic cites to exhibit acidity, and has pores whose pore diameter is on the order of Å and is close to the molecular diameter of HC. Consequently, zeolite is good in terms of the HC adsorbing ability, and can adsorb HC in exhaust gases efficiently.

It has been studied recently to use zeolite in catalysts for purifying automotive exhaust gases by utilizing the characteristics of zeolite. For example, Japanese Unexamined Patent Publication (KOKAI) No. 2-56,247 discloses a catalyst for adsorbing and purifying HC. In the catalyst, an HC adsorbent layer whose major component is zeolite is formed on a support substrate. Moreover, a three-way catalyst layer whose major component is a noble metal is further formed on the HC adsorbent layer.

In accordance with the HC adsorption-purifying catalyst, HC are adsorbed onto the zeolite temporarily in low temperature regions, and are inhibited from being emitted. The adsorbed HC are released from the zeolite when the zeolite is heated to a predetermined temperature or more, and are oxidized and purified by the noble metal existing in the three-way catalytic layer. Therefore, it is possible to stably purify HC from low temperature regions to high temperature regions.

Moreover, Japanese Unexamined Patent Publication (KOKAI) No. 9-225,265 discloses an apparatus for purifying exhaust gases. In the apparatus, a three-way catalyst is disposed on an upstream side of the flow of exhaust gases, and an HC adsorbent in which a zeolite layer is formed on a substrate is disposed on a downstream side with respect to the three-way catalyst. Moreover, the publication sets forth that it is preferable to further form a three-way layer on the zeolite layer.

In addition, Japanese Unexamined Patent Publication (KOKAI) No. 2002-129,951 discloses an apparatus for purifying exhaust gases. In the apparatus, a composite of an NOₓ sorbing catalyst and a three-way catalyst is disposed on an upstream side of the flow of exhaust gases, and an HC adsorption-purifying catalyst which is provided with a three-way catalytic layer formed on an HC adsorbent layer is disposed on a downstream side with respect to the composite.

However, the related HC adsorption-purifying catalyst or apparatus is slow to show the purifying activities in low temperature regions such as when engines are started. As a result, the emission of HC might increase after the amount of HC adsorbed onto the HC adsorbent is saturated.

### SUMMARY OF THE INVENTION

An apparatus according to the present invention is for purifying exhaust gases, and comprises:

an HC adsorption-purifying catalyst including:

an HC adsorbent, and an oxidizing catalyst; and

a three-way catalyst disposed on an upstream side of the flow of exhaust gases with respect to the HC adsorption-purifying catalyst, wherein

a noble metal is loaded higher on a high loading portion disposed on an upstream part of the three-way catalyst than on an ordinary portion of the three-way catalyst.

In the present apparatus for purifying exhaust gases, a loading amount of the high loading portion of the three-way catalyst can desirably be twice or more of a loading amount of the ordinary portion of the three-way catalyst. Moreover, the high loading portion of the three-way catalyst can desirably be formed within a range of ½ of an overall length of the three-way catalyst ranging from an upstream end of the three-way catalyst.

### BRIEF DESCRIPTION OF THE DRAWINGS

FIG. 1 is an explanatory diagram for schematically illustrating an arrangement of an apparatus for purifying exhaust gases according to Example No. 1 of the present invention.

FIG. 2 is an explanatory diagram for schematically illustrating an arrangement of a three-way catalyst used in the present apparatus according to Example No. 1.

FIG. 3 is a graph for illustrating HC emissions as relative values, HC emissions which were exhibited by the present apparatus according to Example No. 1 and an apparatus of Comparative Example No. 1 for purifying exhaust gases.

FIG. 4 is a graph for illustrating the results of Experimental Example No. 2 in which HC emissions are expressed as relative values.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

In the present apparatus for purifying exhaust gases, a three-way catalyst is disposed on an upstream side of the flow of exhaust gases, and an HC adsorption-purifying catalyst is disposed on a downstream side with respect to the three-way catalyst. The three-way catalyst includes an ordinary portion, and a high loading portion which is disposed on an upstream part of the three-way catalyst, and on which a noble metal is loaded higher than it is loaded on the ordinary portion. The HC adsorption-purifying catalyst includes an HC adsorbent, and an oxidizing catalyst.

When engines are started, the low-temperature exhaust gases flow first into the three-way catalyst. The three-way catalyst can exhibit high activities and can oxidize and purify HC in exhaust gases even from low temperatures, because it comprises the high loading portion which is disposed on an upstream side of the flow of exhaust gases and on which a noble metal is loaded in a greater amount. The temperature of exhaust gases is further increased by the heat of the oxidation reaction in this instance. Accordingly, it is possible to shorten the time required for activating the ordinary portion which is disposed on a downstream side with respect to the high loading portion. Consequently, the three-way catalyst can show the HC oxidation activity quickly in a short period of time.

In the HC adsorption-purifying catalyst which is disposed on a downstream side with respect to the three-way catalyst, at least one of the following reactions occurs: HC which have not been oxidized by the three-way catalyst are oxidized by the oxidizing catalyst; and HC are adsorbed onto the HC adsorbent. Note that the three-way catalyst can show the HC oxidation activity promptly. Accordingly, HC are present less in exhaust gases, and remaining HC exist in a smaller amount with respect to the saturated adsorption of the HC adsorbent. Then, the HC remaining in a small amount are adsorbed onto the HC adsorbent. Consequently, the adsorbed HC are eliminated from the HC adsorbent smoothly when the temperature of exhaust gases rises. As a result, it is possible to enhance the purifying efficiency of the oxidizing catalyst. Therefore, the HC adsorption-purifying catalyst can remarkably inhibit the HC emission even in low-temperature regions such as when engines are started.

Thus, the present apparatus for purifying exhaust gases shows the actions of the three-way catalyst and the actions of the HC adsorption-purifying catalyst synergistically. As a result, it is possible to remarkably inhibit the HC emission even in low-temperature regions such as when engines are started.

When the temperature of exhaust gases increases after engines are started, the noble metal loaded on the high loading upstream portion of the three-way catalyst oxidizes most of HC in exhaust gases. The noble metal loaded on the ordinary downstream portion of the three-way catalyst oxidizes HC which have not been oxidized by the high loading upstream portion. In addition, HC adsorbed onto the HC adsorbent of the HC adsorption-purifying catalyst are released from the HC adsorbent when the temperature of exhaust gases increases. However, the released HC are fully oxidized and purified, because the oxidizing catalyst existing in the vicinity of the released HC has been thoroughly activated. Therefore, the present apparatus for purifying exhaust gases hardly emit HC, and can purify HC with a high conversion.

The HC adsorption-purifying catalyst comprises an HC adsorbent, and an oxidizing catalyst. As for the HC adsorbent, zeolite can be a representative option. It is possible to use natural or synthetic zeolite such as mordenite, ZSM-5, type “Y” zeolite, ferrierite and zeolite β. Moreover, it is possible to use at least one member selected from the group consisting of these, or to mix a plurality of them to use.

In general, the oxidizing catalyst comprises a support, such as alumina, and a noble metal, such as Pt, loaded on the support, and oxidizes and purifies HC and CO. As for the oxidizing catalyst, it is possible to use oxidation catalysts or three-way catalysts which have been known conventionally. As for the support, it is possible to exemplify porous oxides, such as alumina, silica, zirconia, titania and ceria, or composite oxides made of at least two members selected from the group consisting of these. Depending on specific cases, it is possible to use zeolite. In this instance, note that the HC adsorbent serves as an oxidizing catalyst as well. Moreover, as for the noble metal loaded on the support, it is possible to use at least one platinum group element selected from the group consisting of Pt, Rh, Pd, Ir and Ru. However, it is desirable to include Pt which exhibits a high oxidizing activity at least. The loading amount of the noble metal usually falls in a range of from 0.1 to 10% by weight with respect to the sum of the support and noble metal taken as 100% by weight. The loading amount of the noble metal can preferably fall in a range of from 0.1 to 8% by weight, further preferably from 0.1 to 6% by weight, furthermore preferably from 0.5 to 5% by weight, with respect to the sum of the support and noble metal taken as 100% by weight.

The HC adsorbent and the oxidizing catalyst can be both formed as a powder, and can be mixed with each other to make the HC adsorption-purifying catalyst. If such is the case, the mixture powder is formed as pellets to make pelletized HC adsorption-purifying catalysts. Alternatively, a slurry containing the mixture powder can be coated on honeycomb substrates made of cordierite or metal, and can be dried and calcined to make honeycomb-shaped HC adsorption-purifying catalyst. Moreover, the honeycomb-shaped HC adsorption-purifying catalyst can be formed in the following manner: a coating layer is formed on a honeycomb substrate by using mixture powders of zeolite powders and oxide powers, such as alumina powders; and a noble metal is loaded on the resulting coating layer.

In addition, the HC adsorption-purifying catalyst can be produced in the following manner: a lower coating layer comprising an HC adsorbent is formed on a honeycomb substrate; and an upper coating layer comprising an oxidizing catalyst is formed on the lower coating layer. On the contrary, a lower coating layer comprising an oxidizing catalyst can be formed on a honeycomb substrate; and an upper coating layer comprising an HC adsorbent can be formed on the lower coating layer. Note that a more preferable option is the former arrangement.

In the HC adsorption-purifying catalyst, the proportion of the HC adsorbent with respect to the oxidizing catalyst can preferably be from 5:1 to 2:3 by volume (i.e., the HC adsorbent:the oxidizing catalyst=from 5:1 to 2:3 by volume). When the proportion deviates from the range, the HC adsorption becomes less or the HC oxidizing ability becomes poor so that the HC emission enlarges. The proportion can further preferably be from 3:1 to 5:6 by volume, furthermore preferably from 2:1 to 1:1 by volume.

Except that the three-way catalyst, which is disposed on an upstream side of the flow of exhaust gases with respect to the HC adsorption-purifying catalyst, comprises the high loading portion which is disposed on an upstream side of the flow of exhaust gases with respect to the ordinary portion, and on which a noble metal is loaded more than the ordinary portion, the three-way catalyst can be made in the same manner as conventional three-way catalysts. Specifically, the three-way catalyst can use at least one porous oxide selected from the group consisting of alumina, silica, zirconia, titania and ceria as a substrate, or a porous oxide composed of at least two porous oxides selected from the group consisting of these as a substrate. Activated alumina is an especially preferable option, because it exhibits high adsorption activities to harmful gaseous components. Moreover, the substrate can preferably further comprise oxides including cerium (Ce). Oxides containing Ce can stabilize the oxygen concentration in exhaust gases, because they are provided with an oxygen storage-and-release capability. Therefore, it is possible to remarkably improve the activities of the three-way catalyst, because oxides containing Ce can turn exhaust gases into the stoichiometric atmosphere stably. Note that it is possible to use ceria as an oxide containing Ce. However, it is further desirable to use composite oxides in which ceria is composited with at least one oxide selected from the group consisting of zirconia and yttiria. When oxides containing Ce are thus composited, it is possible to upgrade the thermal stability of the oxygen storage-and-release capability of ceria. As a result, it is possible to enhance the durability of ceria. In addition, it is possible to use composite oxides in which ceria is composited with metals such as Nd and Sr.

Note that oxides containing Ce can be mixed in a proportion of from 20 to 500 parts by weight with respect to the porous oxide, such as alumina, silica, zirconia, titania and ceria, taken as 100 parts by weight. When oxides containing Ce are mixed in a proportion of less than the lower limit, the advantages resulting from the mixing lower. When oxides containing Ce are mixed in a proportion exceeding the upper limit, the proportion of the porous oxide decreases relatively so that the purifying performance of the resulting substrates has lowered. The proportion can preferably fall in a range of from 20 to 400 parts by weight, further preferably from 30 to 300 parts by weight, with respect to the porous oxide taken as 100 parts by weight.

The noble metal loaded on the support of the three-way catalyst can preferably at least one member selected from the group consisting of Pt, Rh, Pd, Ir and Ru. Among the noble metals, it is desirable to select at least one member from the group consisting of Pt, Rh and Pd. In the three-way catalyst, the loading amount of the noble metal can preferably fall in a range of from 0.1 to 10% by weight of the support on average. When the loading amount is less than the lower limit, the resulting three-way catalysts exhibit lowered HC, CO and NOₓ conversions. When the noble metal is loaded more than the upper limit, not only the advantageous effects of the loaded noble metal saturate but also the cost goes up. Moreover, the loading amount of the noble metal can further preferably fall in a range of from 0.5 to 10% by weight, furthermore preferably from 1 to 8% by weight, of the support on average.

In accordance with the present invention, the three-way catalyst comprises a high loading portion on which the noble metal is loaded more, and an ordinary portion which is disposed on a downstream side of the flow of exhaust gases with respect to the high loading portion, and on which the noble metal is loaded less. It can be satisfactory as far as the noble metal is loaded more on the high loading portion than on the ordinary portion. However, it is desirable that the loading amount of the noble metal on the high loading portion can be twice or more of the loading amount of the noble metal on the ordinary portion. Moreover, the loading amount of the noble metal on the high loading portion can preferably be increased by a factor of from 5 to 10 of the loading amount of the noble metal on the ordinary portion. With such an arrangement, it is possible to further enhance the activities of the three-way catalyst, and accordingly to inhibit the HC emission from much lower temperature regions. Note that, in view of the cost involved, it is preferable that the average loading amount of the noble metal can preferably be 10% by weight of the support.

In addition, it is desirable that the high loading portion can be formed within a range of ½ of the overall length of the three-way catalyst from the upstream end. Moreover, the high loading portion can preferably be formed within a range of from 1/30 to ⅓, further from 1/10 to ⅕, of the overall length of the three-way catalyst from the upstream end.

The three-way catalyst can be formed as pellets. Alternatively, the three-way catalyst can be formed as honeycomb shapes by forming a coating layer on honeycomb substrates made from cordierite or metals. In order to make the high loading portion, it is a preferable option to form the three-way catalyst as honeycomb shapes because it is easy to form the high loading portion. However, even when the three-way catalyst is formed as pellets, it is possible to make the high loading portion with ease by preparing two pelletized catalysts on which the noble metal is loaded in different amounts, respectively, and by filling one of the pelletized catalysts on which the noble metal is loaded more into the upstream side of a container.

The three-way catalyst can preferably be disposed on an immediate downstream side with respect to engines and accordingly be used as a start-up catalyst. This is because exhaust gases emitted from engines can be introduced into the three-way catalyst directly. Thus, the three-way catalyst can be activated much earlier, because the temperature of exhaust gases decreases less. As described above, the HC adsorption-purifying catalyst is disposed on a downstream side with respect to the three-way catalyst.

### EXAMPLES

The present invention will be hereinafter described in detail with reference to a specific example, a comparative example and experimental examples.

### Example No. 1

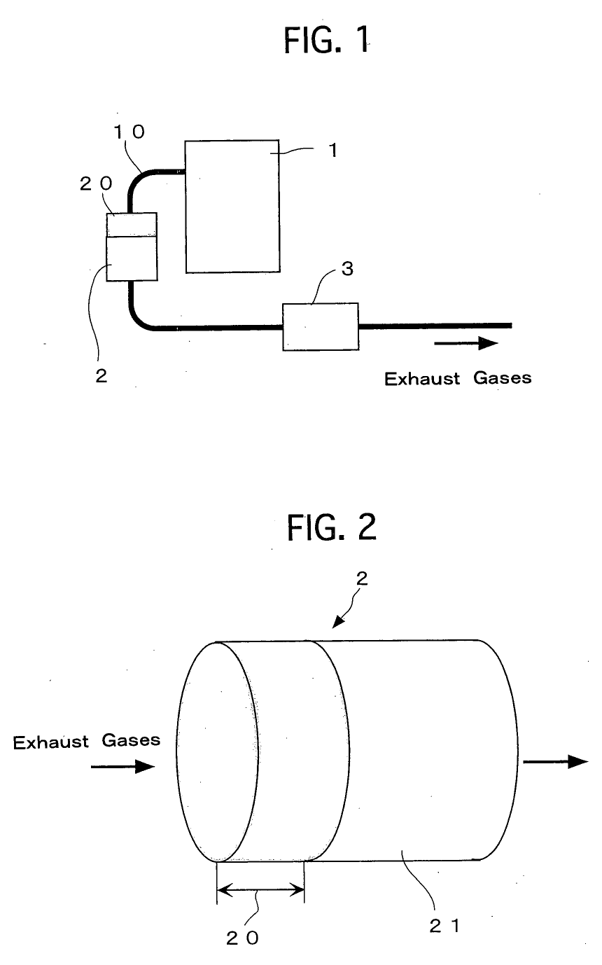

FIG. 1 illustrates an apparatus for purifying exhaust gases according to Example No. 1. The apparatus comprises a three-way catalyst 2, and an HC adsorption-purifying catalyst 3. The three-way catalyst 2 is held in an exhaust pipe 10 which is disposed on an immediate downstream side with respect to an engine 1. The HC adsorption-purifying catalyst 3 is disposed on a downstream side of the flow of exhaust gases with respect to the three-way catalyst 2, and is held in the exhaust pipe 10 which is disposed under a vehicle.

FIG. 2 illustrates the three-way catalyst 2. The three-way catalyst 2 has a length of 100 mm. The three-way catalyst 2 comprises a high loading portion 20, and an ordinary portion 21. The high loading portion is formed over a length of 20 mm from the upstream-side end, and a noble metal is loaded on the high loading portion 20 in a greater amount. The ordinary portion 21 is disposed on a downstream side of the flow of exhaust gases with respect to the high loading portion 20, and the noble metal is loaded on the ordinary portion 21 in an amount less than the loading amount of the noble metal on the high loading portion 20. Hereinafter, how to produce the three-way catalyst 2 (hereinafter referred to as “upstream-side heavily-loaded three-way catalyst 2”) and the HC adsorption-purifying catalyst 3 will be described instead of the detailed descriptions on their arrangements.

### (1) HC Adsorption-Purifying Catalyst

20 parts by weight of an alumina sol, and 400 parts of water were added to 400 parts by weight of a ZSM-5 powder. Note that the alumina sol was used as a binder, and that the addition amount, 20 parts by weight, was the solid alumina content in the alumina sol. The resulting mixture was milled by using a ball mill, thereby preparing a slurry. Meanwhile, a honeycomb substrate was prepared. The honeycomb substrate was made from cordierite, and had a diameter of φ 100 mm and a length of 130 mm. The honeycomb substrate was wash coated with the slurry. The slurry was dried and calcined, thereby forming an HC adsorbent layer on the honeycomb substrate. Note that the HC adsorbent layer was formed in an amount of 150 g with respect to 1 L of the honeycomb substrate.

Subsequently, 5 parts by weight of an alumina sol, and 250 parts of water were added to a mixture powder. Note that the mixture powder comprised 100 parts by weight of an alumina powder, and 60 parts by weight of a ceria powder, and that the addition amount of the alumina sol, 5 parts by weight, was the solid alumina content in the alumina sol. The resulting mixture was milled by using a ball mill, thereby preparing a slurry. The honeycomb substrate provided with the HC adsorbent layer was wash coated with the resulting slurry. The slurry was dried and calcined, thereby forming an upper coating layer on the honeycomb substrate provided with the HC adsorbent layer. Note that the upper coating layer was formed in an amount of 150 g with respect to 1 L of the honeycomb substrate.

Thereafter, the upper coating layer was impregnated with a predetermined amount of a platinum dinitrodiammine aqueous solution having a prescribed Pt concentration. The platinum dinitrodiammine aqueous solution was evaporated to dryness. Then, the upper coating layer was calcined, thereby loading Pt on the upper coating layer. Finally, Rh was loaded on the upper coating layer by using a rhodium nitrate aqueous solution in the same manner as the loading of Pt. Thus, the HC adsorption-purifying catalyst 3 was prepared. Note that the loading amount of Pt and Rh was 3 g and 0.5 g with respect to 1 L of the honeycomb substrate, respectively.

### (2) Upstream-Side Heavily-Loaded Three-Way Catalyst

5 parts by weight of an alumina sol, and 250 parts of water were added to a mixture powder. Note that the mixture powder comprised 100 parts by weight of an alumina powder, and 60 parts by weight of a ceria powder, and that the addition amount of the alumina sol, 5 parts by weight, was the solid alumina content in the alumina sol. The resulting mixture was milled by using a ball mill, thereby preparing a slurry. Meanwhile, a honeycomb substrate was prepared. The honeycomb substrate was made from cordierite, and had a diameter of φ 100 mm and a length of 100 mm. The honeycomb substrate was wash coated with the slurry. The slurry was dried and calcined, thereby forming a coating layer on the honeycomb substrate. Note that the coating layer was formed in an amount of 200 g with respect to 1 L of the honeycomb substrate.

Thereafter, the coating layer was impregnated with a predetermined amount of a platinum dinitrodiammine aqueous solution having a prescribed Pt concentration. The platinum dinitrodiammine aqueous solution was evaporated to dryness. Then, the coating layer was calcined, thereby loading Pt uniformly on the coating layer along the overall length of the honeycomb substrate. Thereafter, Rh was loaded uniformly on the coating layer along the overall length of the honeycomb substrate by using a rhodium nitrate aqueous solution in the same manner as the loading of Pt. Note that the loading amount of Pt and Rh was 1.5 g and 0.4 g with respect to 1 L of the honeycomb substrate, respectively. Finally, the coating layer was further impregnated with a predetermined amount of a platinum dinitrodiammine aqueous solution having a prescribed Pt concentration over a length of 20 mm only from one of the opposite ends of the honeycomb substrate which was to be directed to the upstream side of the flow of exhaust gases. Then, the honeycomb substrate was taken up out of the platinum dinitrodiammine aqueous solution, and was dried and calcined to load Pt by adsorption. Thus, the upstream-side heavily-loaded three-way catalyst 2 was prepared.

In the resulting upstream-side heavily-loaded three-way catalyst 2, the high loading portion 20 was formed over a length of 20 mm from the upstream-side end. The loading amount of Pt and Rh at the high loading portion 20 was 11.5 g and 0.4 g with respect to 1 L of the honeycomb substrate, respectively. The loading amount of Pt and Rh at the ordinary portion 21, which was disposed on a downstream side of the flow of exhaust gases with respect to the high loading portion 21, was 1.5 g and 0.4 g with respect to 1 L of the honeycomb substrate, respectively.

### Comparative Example No. 1

A coating layer was formed on a honeycomb substrate in the same manner as the production process of the upstream-side heavily-loaded three-way catalyst 2 according to Example No. 1. The resulting coating layer was impregnated with a predetermined amount of a platinum dinitrodiammine aqueous solution having a prescribed Pt concentration. The platinum dinitrodiammine aqueous solution was evaporated to dryness. Then, the coating layer was calcined, thereby loading Pt uniformly on the coating layer along the overall length of the honeycomb substrate. Thereafter, Rh was loaded uniformly on the coating layer along the overall length of the honeycomb substrate by using a rhodium nitrate aqueous solution in the same manner as the loading of Pt. The loading amount of Pt and Rh was 3.5 g and 0.4 g with respect to 1 L of the honeycomb substrate, respectively. Thus, a uniformly-loaded three-way catalyst was prepared. Note that the total loading amount of Pt and Rh was identical with that the upstream-side heavily-loaded three-way catalyst 2 according to Example No. 1, respectively.

The resultant uniformly-loaded three-way catalyst was disposed on an immediate downstream side with respect to an engine 1 instead of the upstream-side heavily-loaded three-way catalyst 2 according to Example No. 1. Moreover, the same HC adsorption-purifying catalyst as the HC adsorption-purifying catalyst 3 according to Example No. 1 was disposed on a downstream side with respect to the uniformly-loaded three-way catalyst. Thus, a comparative apparatus for purifying exhaust gases was prepared, and was labeled as Comparative Example No. 1.

### Experimental Example No. 1

The exhaust gas-purifying apparatuses of Example No. 1 and Comparative Example No. 1 were subjected to an aging treatment, respectively. In the aging treatment, exhaust gases flowed through the respective apparatuses for 100 hours under the following conditions: a gasoline engine whose displacement was 2.4 L was used as the engine 1; the gasoline engine was run at a speed of 3,600 rpm; and the inlet-gas temperature was 850° C. at the upstream-side catalyst (i.e., the upstream-side heavily-loaded three-way catalyst 2 or the uniformly-loaded three-way catalyst). Thereafter, the apparatuses were installed to an exhaust system of a gasoline engine whose displacement was 2.4 L, respectively, and were subjected to the LA#4 mode emission test in accordance with the stipulated procedure. Note that not only the outlet gas from the HC adsorption-purifying catalyst 3 but also the inlet gas into the HC adsorption-purifying catalyst 3 were collected in the LA#4 mode emission test.

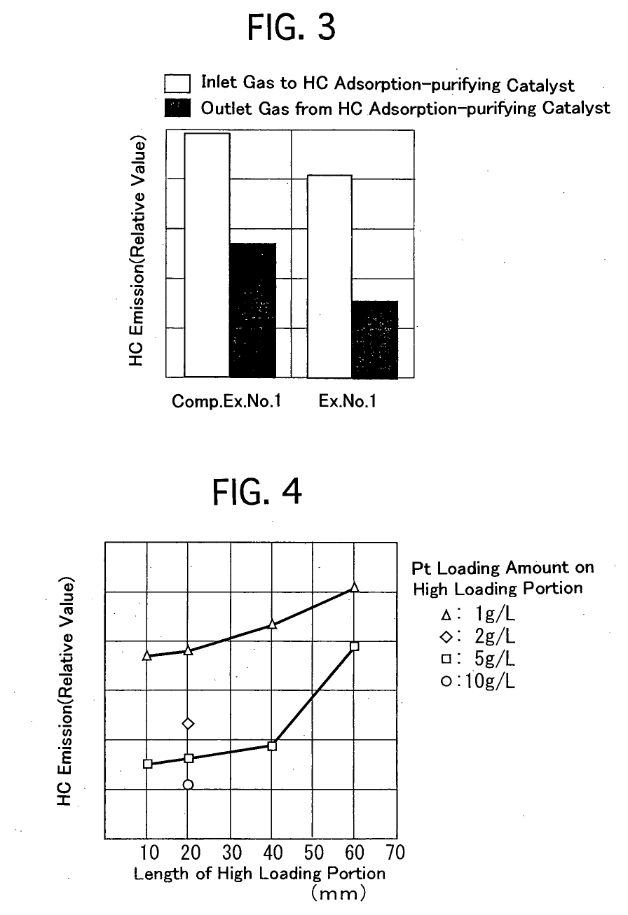

The exhaust gas-purifying apparatuses of Example No. 1 and Comparative Example No. 1 were examined for the HC emission in exhaust gases for 505 seconds after starting the LA#4 mode emission test, respectively. FIG. 3 illustrates the results of the measurement as relative values.

It is understood from FIG. 3 that the exhaust gas-purifying apparatus of Example No. 1 reduced the HC emission in the outlet gas from the HC adsorption-purifying catalyst 3 by about 40% more than the exhaust gas-purifying catalyst of Comparative Example No. 1 did. Meanwhile, the exhaust gas-purifying apparatus of Example No. 1 reduced the HC emission in the outlet gas from the upstream-side heavily-loaded three-way catalyst 2 (or the HC emission in the inlet gas to the HC adsorption-purifying catalyst 3) by about 18% more only than the exhaust gas-purifying catalyst of Comparative Example No. 1 reduced the HC emission in the outlet gas from the uniformly-loaded three-way catalyst. Considering the fact that the exhaust gas-purifying apparatuses of Example No. 1 and Comparative Example No. 1 used the same HC adsorption-purifying catalyst, it is apparent that the synergetic action of the upstream-side heavily-loaded three-way catalyst 2 and HC adsorption-purifying catalyst 3 enabled the exhaust gas-purifying apparatus of Example No. 1 to sharply reduce the HC emission for 505 seconds after starting the LA#4 mode emission test.

### Experimental Example No. 2

A plurality of the upstream-side heavily-loaded three-way catalysts 2 were prepared as set forth in Table 1 below. Specifically, the length of the high loading portion 20 of the three-way catalyst 2 was varied on four levels, 10 mm, 20 mm, 40 mm and 60 mm; the loading amount of Pt on the high loading portion 20 was varied on four levels, 1 g, 2 g, 5 g and 10 g with respect to 1 L of the honeycomb substrate; and the loading amount of Pt on the ordinary portion 21 was adjusted so that the total loading amount of Pt was identical with each other on the resulting upstream-side heavily-loaded three-way catalysts 2. Moreover, Rh was loaded uniformly over the entire three-way catalysts 2 in an amount of 0.4 g with respect to 1 L of the honeycomb substrate. Note that some of the resulting three-way catalysts 2 which had the ordinary portion 21 on which Pt was loaded more than it was loaded on the high loading portion 20 are listed in Table 1 for comparison.

TABLE 1

| Length of | Pt Loading Amount on | | | | |
|---|---|---|---|---|---|
| High Loading | High Loading Portion | | | | |
| Portion (mm) | (g/L) | 1 | 2 | 5 | 10 |
| 10 | Pt Loading Amount on | 3.4 | N.P. | 3.0 | N.P. |
| 20 | Ordinary Portion | 3.3 | 3.1 | 2.5 | 1.5 |
| 40 | (g/L) | 3.1 | N.P. | 1.5 | N.P. |
| 60 | | 2.9 | N.P. | 0.5 | N.P. |

Note:
“N.P.” stands for “not prepared.”

The thus prepared upstream-side heavily-loaded three-way catalysts were disposed on an upstream side with respect to the same HC adsorption-purifying catalyst 3 as Example No. 1, respectively. Then, in the same manner as described in Experimental Example No. 1, the resulting exhaust gas-purifying apparatuses were subjected to the aging treatment and the LA#4 mode emission test, respectively. Thus, the exhaust gas-purifying apparatuses were examined for the HC emission in exhaust gases for 505 seconds after starting the LA#4 mode emission test, respectively. FIG. 4 illustrates the results of the measurement as relative values.

When the upstream-side heavily-loaded three-way catalysts having the high loading portion 20 whose length was 20 mm are compared, it is understood from FIG. 4 and Table 1 that the high loading portion 21 can preferably be loaded with Pt in an amount of twice or more than the ordinary portion 20 is loaded therewith. Moreover, when the upstream-side heavily-loaded catalysts having the high loading portion 20 on which Pt was loaded in an amount of 5 g with respect to 1 L of the honeycomb substrate, it is seen that the length of the high loading portion 20 can desirably be within 50 mm. In addition, when the length of the high loading portion 21 exceeded 40 mm, the HC emission increased markedly. Accordingly, it is appreciated that the length of the high loading portion 20 can further desirably be 40 mm or less.

Having now fully described the present invention, it will be apparent to one of ordinary skill in the art that many changes and modifications can be made thereto without departing from the spirit or scope of the present invention as set forth herein including the appended claims.

What is claimed is:

1. An apparatus for purifying exhaust gases, comprising:
an HC adsorption-purifying catalyst including:
an HC adsorbent, and an oxidizing catalyst; and
a three-way catalyst disposed on an upstream side of the flow of exhaust gases with respect to the HC adsorption-purifying catalyst, wherein
a noble metal is loaded higher on a high loading portion disposed on an upstream part of the three-way catalyst than on an ordinary portion of the three-way catalyst.

2. The apparatus set forth in claim 1, wherein a loading amount of the high loading portion of the three-way catalyst is twice or more of a loading amount of the ordinary portion of the three-way catalyst.

3. The apparatus set forth in claim 1, wherein the high loading portion of the three-way catalyst is formed within a range of ½ of an overall length of the three-way catalyst ranging from an upstream end of the three-way catalyst.

4. The apparatus set forth in claim 1, wherein the HC adsorption-purifying catalyst includes the HC adsorbent and the oxidizing catalyst with a proportion of the HC adsorbent with respect to the oxidizing catalyst from 5:1 to 2:3 by volume.
